(19) United States
(12) Patent Application Publication
(10) Pub. No.: US 2010/0070302 A1
(43) Pub. Date: Mar. 18, 2010

(54) SYSTEMS AND METHODS FOR CREATING A DIETARY PLAN BASED ON A CLINICAL ELEMENT MODEL

(75) Inventor: David P. Murawski, Cary, IL (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/209,568

(22) Filed: Sep. 12, 2008

(51) Int. Cl. G06Q 50/00

(52) U.S. Cl. 705/3; 705/2

(57) ABSTRACT

Certain embodiments provide systems and methods for dietary planning and monitoring according to a clinical element model. A method includes creating a dietary plan for a patient. The dietary plan includes dietary items and relationships between dietary items implemented according to a clinical element model, for example. The method also includes receiving input regarding a dietary item. The input includes an identifier for the dietary item and contents of the dietary item, for example. The method further includes mapping the dietary item to a clinical element model based on the input. The method additionally includes providing the clinical element model for the dietary item in conjunction with the dietary plan.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to creation of dietary plans for patient care. More particularly, for example, the present invention relates to methods and systems for creating dietary plans using a clinical element model.

Healthcare practice has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be used by clinicians to review, diagnose, and help treat a patient. Healthcare practitioners may desire to access and/or distribute patient information or other information at various points in a healthcare workflow. However, currently, not all information related to patient is electronically stored and processed in a usable form, if at all.

### BRIEF SUMMARY OF THE INVENTION

Certain embodiments of the present invention provide methods and systems for mobile, location-based access to healthcare provider information.

Certain embodiments provide a method for dietary planning and monitoring according to a clinical element model. The method includes creating a dietary plan for a patient. The dietary plan includes dietary items and relationships between dietary items implemented according to a clinical element model, for example. The method also includes receiving input regarding a dietary item. The input includes an identifier for the dietary item and contents of the dietary item, for example. The method further includes mapping the dietary item to a clinical element model based on the input. The method additionally includes providing the clinical element model for the dietary item in conjunction with the dietary plan.

Certain embodiments provide a system enabling dietary planning and monitoring. The system includes a library of clinical element models representing dietary items, a clinical subsystem including a dietary plan, and an input receiving information regarding a dietary item. The information regarding the dietary item is translated into a clinical element model for the dietary item using the library. The clinical element model for the dietary item is compared to the dietary plan to determine acceptability of the dietary item under the dietary plan.

Certain embodiments provide a machine-readable medium including a set of instructions for execution by a computing device. The set of instructions include an input routine receiving input regarding a dietary item. The input includes an identifier for the dietary item and contents of the dietary item, for example. The set of instructions also includes a mapping routine mapping the dietary item to a clinical element model based on the input. The set of instructions also includes an output routine providing the clinical element model for the dietary item in conjunction with a dietary plan. The dietary plan includes dietary items and relationships between dietary items implemented according to a clinical element model, for example.

### BRIEF DESCRIPTION OF SEVERAL VIEWS OF THE DRAWINGS

FIG. 1 depicts an exemplary clinical element model in accordance with an embodiment of the present invention.

FIG. 2 illustrates a system for dietary planning and monitoring in accordance with an embodiment of the present invention.

FIG. 3 illustrates a flow diagram for a method for dietary planning and monitoring according to an embodiment of the present invention.

FIG. 4 illustrates an example of a clinical information system used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods to create dietary plans for patient. For example, certain embodiments creating dietary plans using a clinical element model.

Certain embodiments provide a patient dietary plan based on a clinical element model. Using a clinical element model, each clinical element has its own object and its own modifiers and qualifiers. Certain embodiments utilize a clinical element model to define food so that the food people ingest can be tracked in a clinical setting as medication would be tracked. Then a clinician can review and determine how a certain diet would impact a care plan for a patient.

Certain embodiments provide a Clinical Element Model (“CEM”) as a base for a dietary plan of care. The CEM is a way to represent a clinical piece of data such as “Heart Rate”, for example. The CEM for “Heart Rate” can be used to describe a value plus additional qualifiers and modifiers such as where the value was obtained, how the value was obtained, what the person was doing at the time, family history, etc. The CEM gives a much broader picture than the value alone. Additionally, in a CEM, each qualifier/modifier can have its own qualifiers and/or modifiers (e.g., blood pressure was taken on the patient's right arm, and the right arm was raised).

Clinicians can track data based on CEMs to help identify trends and to predict outcomes. With CEMs representing food, clinicians can track trends in patient data in conjunction with the food the patient eats.

Certain embodiments provide a library of CEMs made for various commercial foods. The library can, for example, also include an interface to accept additional foods and/or modify CEMs for foods already in the library.

In certain embodiments, the CEM food library can work in conjunction with a device that can scan food barcodes and/or other identifiers to aid in tracking what a patient consumes. For example, if a doctor places a patient on a restrictive diet, the patient can use a barcode scanning device to scan items to determine whether the food items are acceptable to consume according to the diet plan. When a patient visits his or her physician, this data can be downloaded and tracked. This data can be used in conjunction with other clinical data to help determine an effect of certain food intake on activity such as blood pressure, heart rate, cholesterol, sugar level, etc.

A CEM can be applied to what a patient consumes. For example, a CEM can be generated for “a Sandwich”, which can include qualifiers and modifiers such as, what type of meat, and/or bread, cooked/cold, lettuce or no lettuce, salt added (how much), etc. CEMs can be used in conjunction with patient medical record data to track an effect of what a patient consumes on the patient's physical properties and vitals, for example. Characterizing food items as CEMs can also aid in supporting and controlling a dietary plan. If consumers are tracking their intake via devices that represent food item data as one or more CEMs, they can take this information with them to their doctors who can interpret and display this information, for example.

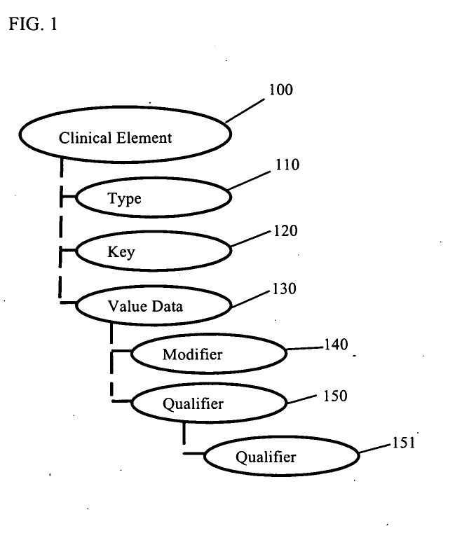

A clinical element model is a conceptual model representing a piece of clinical data, such as a blood pressure model, heart rate model, lab panel model, order model, food model, etc. For each clinical element, a type or name of a particular model, a key or identifier linking the model to an external coded terminology, and a value can be specified. In certain embodiments, a key, for example, may be omitted from the CEM. The value can include the value data as well as one or more modifiers and/or qualifiers regarding that value data. In certain embodiments, one or more modifiers and/or qualifiers can be chained off of one or more other modifiers and/or qualifiers, for example. FIG. 1 depicts an exemplary clinical element model 100 including a type 110, a key 120, a value data 130, a modifier 140, and a plurality of qualifiers 150, 151 as described above.

Value data can include Health Level Seven (“HL7”), Digital Imaging and Communications in Medicine (“DICOM”), Logical Identifier Names and Codes (“LOINC”), and/or other standardized value data, for example. The key 120 can be used to indicate which vocabulary (e.g., HL7, DICOM, LOINC, etc.) is being used for the value data. Modifiers can indicate changes to a meaning of the value data. For example, a blood pressure reading was taken after exercise. A qualifier can provide additional information about the value data. For example, the blood pressure reading was taken on the patient's right arm. A further qualifier may include that the blood pressure reading was taken from the patient's right arm and that arm was elevated, for example. Thus, for example, a CEM can provide a type of measurement, a location of measurement, a laterality of measurement, and a measurement value.

In certain embodiments, a standard set of CEMs can be created in conjunction with a set of coded terminology and interface specifications for healthcare applications. Open sharing of models, coded terms, and interface specifications help enable the CEMs to store, track, query, and use data in clinical applications and patient care. CEMs can be constructed according to a standard logical model and syntax and can be accessed via one or more repositories or libraries, for example. CEMs may be programmed using eXtensible Markup Language (“XML”) and/or other programming language, for example.

CEMs help facilitate exchange of medical data between different clinical systems while maintaining EMR consistency. A patient's EMR can be represented and viewed as a series of CEMs including CEMs representing laboratory results, drug orders, vital signs, patient care plans, dietary plans, etc. In certain embodiments, multiple patient EMRs and/or de-identified versions of patient EMRs may be linked using CEMs.

FIG. 1 illustrates an example clinical element model 100 including a type 110, a key 120, and value data 130 including a modifier 140 and a plurality of qualifiers 150-151. The CEM 100 can be used, for example, to model a cheeseburger having toppings—onion, lettuce, tomato, cheese of type—cheddar, and degree of doneness—medium. As another example, the CEM 100 can be used to represent a patient's temperature having a value of 98.6 degree Fahrenheit, where the temperature was taken—at the patient's armpit, when the temperature was taken—the patient had just been running, what a normal temperature is for that patient, etc. The temperature could include further qualifiers, such as the armpit used was the left armpit, the armpit was shaved, etc. As a further example, the CEM 100 can be used to represent a heartrate having a certain value. Qualifiers for that heartrate may include that the heartrate was measured while the patient was on a treadmill. A further qualifier may indicate an amount of time for which the patient had been on the treadmill at the time of heartrate measurement. Further modifiers/qualifiers may include a family history for high heartrate, a normal value for the patient's heartrate, etc.

CEM data can be used in a clinical system to review results and identify trends in the information. CEMs modeling food can be used to look at trends with relation to what a patient is eating. The food CEM can include qualifiers and/or modifiers such as the food is high in sodium, the food has certain preservatives, etc. A clinician can review a patient's CEM data and determine that, for example, foods eaten in the last year have red dye #6, so the clinician can order that the patient stop eating such foods to determine if the patient's malady disappears. By representing food as a CEM, rather than simply looking at nutrition information labeled on the food packaging, a plurality of food data can be viewed, combined with patient vitals (e.g., blood pressure, weight, etc.), lab results (e.g., cholesterol), etc., and trends can be examined to determine impact on patient health and patient care. Capturing food intake as CEM data helps to provide more of a controlled environment for a physician to determine what ails a patient.

In certain embodiments, a bar code reader can be used to scan foods and upload information into a clinical system to create CEMs. A physician can review the food CEM information and formulate a dietary plan for the patient. Scanning and capturing food as CEM information helps a patient and his or her physician know and control exactly what the patient eats and see how the patient's diet is affecting his or her life. For example, using a bar code reader, a patient can scan an item and see the CEM model for the item so that the patient can review the data before eating the item, as well as reviewing the information after consuming a particular food.

Thus, a CEM where a value can have a qualifier and/or modifier, and each qualifier/modifier can have a qualifier and/or modifier, provides greater meaning to a static value than the value itself would provide in a chart. In certain embodiments, a flowsheet can be used to access CEM data. The flowsheet can display the CEM value. When a user mouses over the value (e.g., floats over it with the cursor), qualifiers and/or modifiers for that value are shown. Alternatively or in addition, by clicking on or selecting the value in the flowsheet or other chart, the entry may expand to show any qualifier(s) and/or modifier(s), for example.

In certain embodiments, a patient, for example, can visit a physician, who instructs the patient to follow a certain diet regime. The diet plan can be tied to a series of CEMs and related rules regarding dietary limitations. The patient can install an application, for example, and/or access content via a network such as the World Wide Web to interact with the dietary plan. The patient can track the plan and associated information, as well as look up information regarding different foods he or she should and/or should not eat using a CEM library of information, for example. In certain embodiments, the patient can enter information regarding the food he or she is eating, and that information is converted into CEM information and stored with respect to the patient's dietary plan. The physician can then also track the patient's status based on the plan and the entered food information.

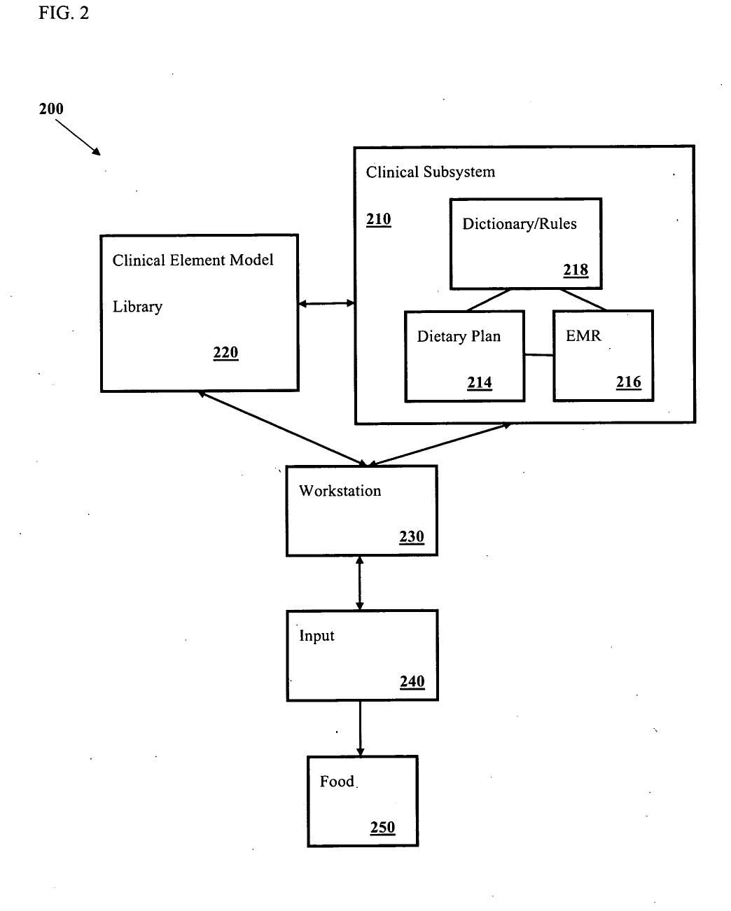

FIG. 2 illustrates a system 200 for dietary planning and monitoring in accordance with an embodiment of the present invention. The system 200 includes a clinical subsystem 210, which includes a dietary plan 214 and an EMR 216. The system 200 also includes a CEM library 220, a client workstation 230, and an input device 240. The system 200 can be used to process a dietary item 250, for example. The clinical subsystem 210, dietary plan 214, EMR 216, library 220, workstation 230, and input device 240 may be implemented in hardware, software, and/or firmware, for example, individually and/or in one or more integrated units, for example. The dietary item 250 may include a bar code, magnetic strip, radio frequency identifier, alphanumeric marking, and/or other identifier on the item 250 itself and/or on packaging for the item 250, for example.

In certain embodiments, the CEM library 220 and/or subsystem 210 may include at least one of a CEM dictionary and rules 218 to aid in structuring a CEM and its behavior, for example. While the dictionary and rules 218 are depicted in conjunction with the clinical subsystem 210, they may be implemented separately and/or in conjunction with the library 220, for example. As another example, a local set of dictionary and rules may exist on the workstation 230.

The clinical subsystem 210 accesses the dietary plan 214 and EMR 216 to exchange data and process results, for example. In certain embodiments, the clinical subsystem 210 can communicate with the library 220 to retrieve CEM information to process in conjunction with the dietary plan 214 and/or EMR 216 information. The workstation 230 communicates with the clinical subsystem 210 to provide information from a user, such as input dietary item 250 information and/or patient medical record information. In certain embodiments, the workstation 230 can communicate with the library 220 to associate dietary item 250 information with one or more CEMs, for example. The workstation 230 can receive information regarding the dietary item 250 via the input device 240. The input device 240 can include a scanner, a keyboard, a mousing device, a touchscreen, and the like.

The dietary item 250 is an edible item, such as a solid and/or liquid food and/or drink. A user can scan or otherwise input identification for the dietary item 250 into the workstation 230 via the input device 240. For example, a user can scan a sandwich purchased at the store into the workstation 230 via a barcode on the sandwich wrapper scanned by a barcode reader input device 240. Alternatively, a user can manually enter dietary item 250 information into the workstation 230 via a keyboard input device 240, for example.

The workstation 230 can then provide the dietary item 250 information for association with a CEM from the CEM library 220. For example, the workstation 230 can provide the dietary item 250 information to the clinical subsystem 210 to associate the dietary item 250 with a CEM from the CEM library 220. As another example, the workstation 230 can retrieve CEM information from the CEM library 220 and/or otherwise perform a look-up in the CEM library 220 to associate the dietary item 250 with a CEM and/or create a new CEM for the dietary item 250. In certain embodiments, the library 220 can be updated based on the dietary item 250 CEM. In certain embodiments, a plurality of CEMs and/or a nested CEM may be used to represent the dietary item 250. In certain embodiments, a set of CEM dictionary and rules 218 can be used to formulate a CEM for the dietary item 250.

The dietary item 250 CEM is provided to the clinical subsystem 210 for incorporation into the dietary plan 214 and/or EMR 216. The patient and/or a clinician can access the dietary plan 214 and/or EMR 216 to view the patient's progress or status and analyze an effect of the dietary item 250 on the dietary plan 214 and/or other patient data, for example.

In certain embodiments, a user creating a CEM for a dietary item 250 can launch computer software on the workstation 230 to create the CEM. When the user launches computer software to create the CEM, the computer software may access the CEM library 220 as well as, in certain embodiments, a CEM dictionary and rules 218, for example. The CEM library 220 includes a list of available CEMs including qualifiers and/or modifiers to represent the dietary item 250 and its characteristics and/or context, for example. In certain embodiments, once available CEM(s) are identified, the dictionary and rules 218 can be used to determine a set of parameters related to qualifier(s) and/or modifier(s) for each applicable CEM. In certain embodiments, the dictionary and rules 218 can be used to determine behavioral rules and/or other information governing the CEM(s) as well. Behavioral rules can direct functionality and/or interrelationship of information in a CEM and/or between CEMs, for example. Rules can also direct usage of one or more CEMs in clinical applications, for example. The CEM(s) can then be provided to the workstation 230, clinical subsystem 210, and/or library 220 for display, storage, and/or further use, for example.

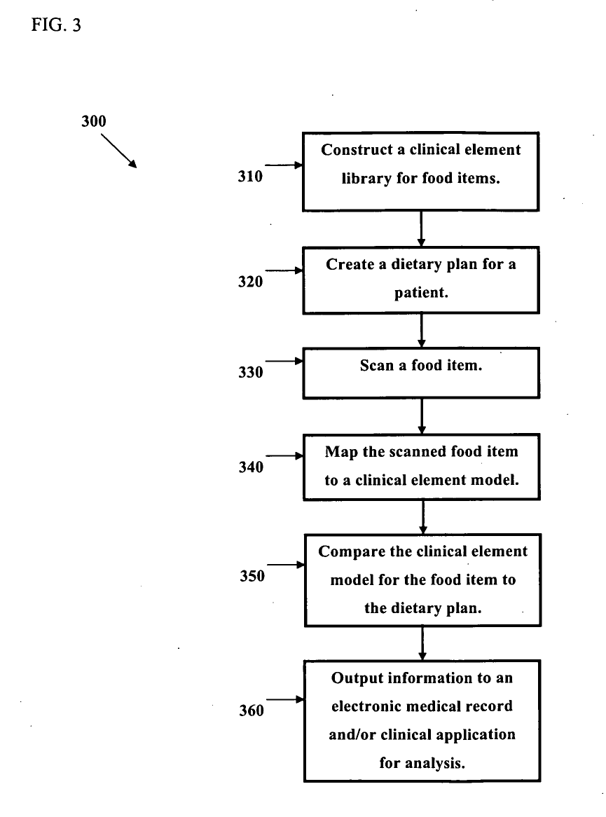

FIG. 3 illustrates a flow diagram for a method 300 for dietary planning and monitoring according to an embodiment of the present invention. At 310, a library of CEMs is constructed for food items. At 320, a dietary plan is created for a patient. At 330, a food item is scanned. At 340, the scanned food item is mapped to a CEM. At 350, the CEM for the food item is compared to the dietary plan. At 360, information is output to an EMR and/or clinical application for analysis.

The method 300 will now be discussed in additional detail. At 310, a library of CEMs is constructed for food items. For example, as discussed above, CEMs representing a variety of foods may be constructed manually by a user and/or automatically by computer software given a set of parameters, rules, and/or other constraints and/or relationships. For example, a CEM can be created for spaghetti with qualifiers and/or modifiers indicating a type of sauce (e.g., tomato), a type of meat (e.g., beef), a type of pasta (e.g., spaghetti noodle), and fundamental ingredients (e.g., tomatoes, beef, flour, etc.) for each component. Further information in the CEM can specify a health value (e.g., calories, cholesterol, sodium, etc.) for each ingredient/component.

At 320, a dietary plan is created for a patient. For example, a clinician can utilize a computer system and related software to create a dietary plan of particular foods, types of foods, quantities of foods, relationships of foods, timing, etc., for a patient to eat and/or avoid. The clinician may manually generate the dietary plan using the computer software and related resources and/or may execute a computer program to have the dietary plan automatically generated given certain input information. The dietary plan can be constructed in conjunction with a library of CEMs representing the food items (and relationships) in the plan, for example. The dietary plan can be saved, such as in a clinical subsystem such as a clinical information system.

At 330, a food item is scanned. For example, a user can input identifying information regarding the food item for matching with a CEM. As another example, a barcode, magnetic strip, RFID, and/or other identifier can be scanned to provide an indication of the food item for matching with a CEM and/or new CEM creation.

At 340, the scanned food item is mapped to a CEM. For example, based on the input identification information, the food item and its characteristics/properties can be matched to an existing CEM from a library or database and/or can be used to create a new CEM using the food item name and characteristics and/or properties of the food item such as component parts, ingredients, health information, preparation information, etc.

At 350, the CEM for the food item is compared to the dietary plan. For example, once the food item has been reduced to CEM form, the CEM structure and contents can be applied to guidelines specified in the dietary plan. For example, a computer program can automatically determine how the food item fits into the dietary plan. Alternatively and/or in addition, a clinician can review the information. In certain embodiments, the food item CEM information can be used to update the dietary plan and/or track the patient's progress.

At 360, information is output to an EMR and/or clinical application for analysis. For example, a clinical application can provide trend information, track certain food items and/or food content, analyze patient vitals in conjunction with food intake, and store food CEM and analysis information in the EMR and/or other data store. In certain embodiments, examinations, laboratory tests, and/or other actions can be ordered based on the CEM and dietary plan analysis, for example.

One or more of the steps of the method 300 can be implemented alone or in combination in hardware, firmware, and/or as a set of instructions in software, for example. Certain embodiments can be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

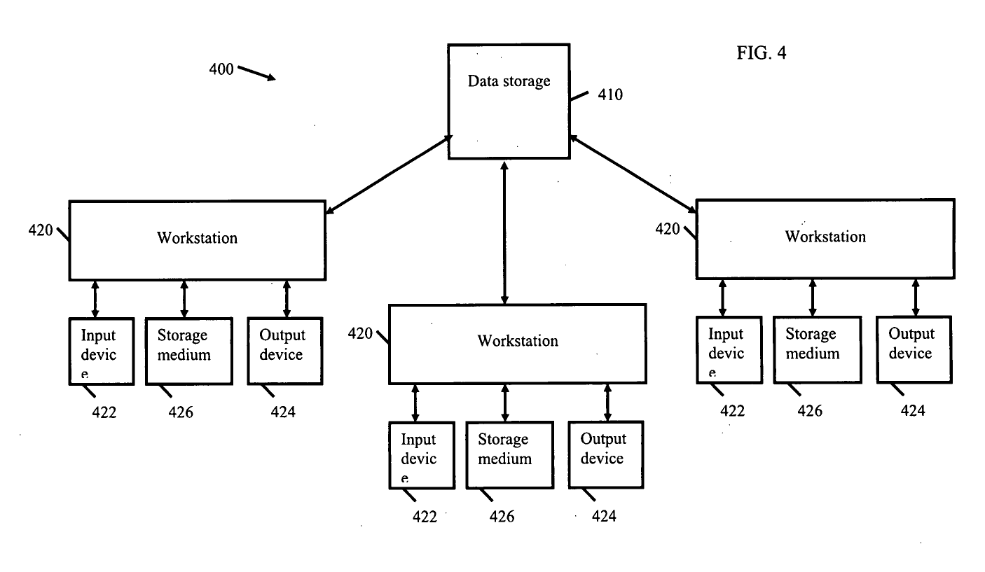

In certain embodiments, the systems and methods described above can be implemented and/or used in conjunction with a clinical information system such, as the system 400 as shown and described in FIG. 4. In certain embodiments, an interface including patient information and images may be viewed and/or constructed using a system such as system 400 including at least one data storage 410 and at least one workstation 420. While three workstations 420 are illustrated in system 400, a larger or smaller number of workstations 1420 can be used in accordance with embodiments of the presently described technology. In addition, while one data storage 410 is illustrated in system 400, system 1000 can include more than one data storage 410. For example, each of a plurality of entities (such as remote data storage facilities, hospitals or clinics) can each include one or more data stores 410 in communication with one or more workstations 420.

As illustrated in system 400, one or more workstations 420 can be in communication with at least one other workstation 420 and/or at least one data storage 410. Workstations 420 can be located in a single physical location or in a plurality of locations. Workstations 420 can be connected to and communicate via one or more networks.

Workstations 420 can be directly attached to one or more data stores 410 and/or communicate with data storage 410 via one or more networks. Each workstation 420 can be implemented using a specialized or general-purpose computer executing a computer program for carrying out the processes described herein. Workstations 420 can be personal computers or host attached terminals, for example. If workstations 420 are personal computers, the processing described herein can be shared by one or more data stores 410 and a workstation 420 by providing an applet to workstation 420, for example.

Workstations 420 include an input device 422, an output device 424 and a storage medium 426. For example, workstations 420 can include a mouse, stylus, microphone and/or keyboard as an input device. Workstations 420 can include a computer monitor, liquid crystal display (“LCD”) screen, printer and/or speaker as an output device.

[109] Storage medium 426 of workstations 420 is a computer-readable memory. For example, storage medium 426 can include a computer hard drive, a compact disc (“CD”) drive, a USB thumb drive, or any other type of memory capable of storing one or more computer software applications. Storage medium 426 can be included in workstations 420 or physically remote from workstations 420. For example, storage medium 426 can be accessible by workstations 420 through a wired or wireless network connection.

Storage medium 426 includes a set of instructions for a computer. The set of instructions includes one or more routines capable of being run or performed by workstations 420. The set of instructions can be embodied in one or more software applications or in computer code.

Data storage 410 can be implemented using a variety of devices for storing electronic information such as a file transfer protocol (“FTP”) server, for example. Data storage 410 includes electronic data. For example, data storage 410 can store patient exam images and/or other information, electronic medical records, patient orders, etc., for a plurality of patients. Data storage 410 may include and/or be in communication with one or more clinical information systems, for example.

Communication between workstations 420, workstations 420 and data storage 410, and/or a plurality of data stores 410 can be via any one or more types of known networks including a local area network (“LAN”), a wide area network (“WAN”), an intranet, or a global network (for example, Internet). Any two of workstations 420 and data stores 410 can be coupled to one another through multiple networks (for example, intranet and Internet) so that not all components of system 400 are required to be coupled to one another through the same network.

Any workstations 420 and/or data stores 410 can be connected to a network or one another in a wired or wireless fashion. In an example embodiment, workstations 420 and data store 410 communicate via the Internet and each workstation 420 executes a user interface application to directly connect to data store 410. In another embodiment, workstation 420 can execute a web browser to contact data store 410. Alternatively, workstation 420 can be implemented using a device programmed primarily for accessing data store 410.

Data storage 410 can be implemented using a server operating in response to a computer program stored in a storage medium accessible by the server. Data storage 410 can operate as a network server (often referred to as a web server) to communicate with workstations 420. Data storage 410 can handle sending and receiving information to and from workstations 420 and can perform associated tasks. Data storage 410 can also include a firewall to prevent unauthorized access and enforce any limitations on authorized access. For instance, an administrator can have access to the entire system and have authority to modify portions of system 400 and a staff member can only have access to view a subset of the data stored at data store 410. In an example embodiment, the administrator has the ability to add new users, delete users and edit user privileges. The firewall can be implemented using conventional hardware and/or software.

Data store 410 can also operate as an application server. Data store 410 can execute one or more application programs to provide access to the data repository located on data store 410. Processing can be shared by data store 410 and workstations 420 by providing an application (for example, a java applet). Alternatively, data store 410 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 410 can be implemented using a variety of devices for storing electronic information such as an FTP server. It is understood that the storage device can be implemented using memory contained in data store 410 or it may be a separate physical device. The storage device can include a variety of information including a data warehouse containing data such as patient medical data, for example.

Data storage 410 can also operate as a database server and coordinate access to application data including data stored on the storage device. Data storage 410 can be physically stored as a single database with access restricted based on user characteristics or it can be physically stored in a variety of databases.

In an embodiment, data storage 410 is configured to store data that is recorded with or associated with a time and/or date stamp. For example, a data entry can be stored in data storage 410 along with a time and/or date at which the data was entered or recorded initially or at data storage 410. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 410 is configured to store image and/or other medical data for a patient. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

Thus, certain embodiments provide a technical effect of representing food in a clinical element model. Certain embodiments help standardize food descriptions and component relationships for tracking, storage, and/or analysis, for example. Certain embodiments facilitate creation of dietary plans using the clinical element model to allow and/or restrict food in a patient's diet. Certain embodiments provide hand held devices to scan food that follow these guidelines and keep track of food intake. Certain embodiments upload information to clinical applications to show trends against other clinical elements. Certain embodiments allow storage and viewing of patient dietary intake alone and/or in conjunction with electronic medical record and clinical application information. Certain embodiments allow a physician to review a patient's eating patterns, types of food, values and other information for that food, and analyze how that food intake affects the patient's vitals and other information. Certain embodiments help to create and/or modify a dietary and/or other care plan for the patient.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

For example, certain embodiments provide a machine-readable medium including a set of instructions for execution by a computing device. The set of instructions may include an input routine receiving input regarding a dietary item. The input may include an identifier for the dietary item and contents of the dietary item, for example. The set of instructions may also include a mapping routine mapping the dietary item to a clinical element model based on the input. The set of instructions may also include an output routine providing the clinical element model for the dietary item in conjunction with a dietary plan. The dietary plan may include dietary items and relationships between dietary items implemented according to a clinical element model, for example. In certain embodiments, the clinical element model for the dietary item is output to at least one of a clinical application and an electronic medical record, for example. In certain embodiments, the set of instructions include an analysis routine to analyze an affect of the dietary item on a patient's vital signs using the clinical element model, for example. In certain embodiments, the set of instructions includes an analysis routine to determine whether the dietary item complies with the dietary plan using the clinical element model, for example. In certain embodiments, the mapping routine utilizes at least one of a clinical element model dictionary and behavioral rules to map the dietary item to a clinical element model. In certain embodiments, the mapping routine standardizes a representation of the dietary item using a clinical element model based on a library of clinical element models for dietary items.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of healthcare information systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for dietary planning and monitoring according to a clinical element model, said method comprising:
creating a dietary plan for a patient, the dietary plan including dietary items and relationships between dietary items implemented according to a clinical element model;
receiving input regarding a dietary item, said input including an identifier for said dietary item and contents of said dietary item;
mapping said dietary item to a clinical element model based on said input; and
providing said clinical element model for said dietary item in conjunction with said dietary plan.

2. The method of claim 1, wherein said providing further comprises comparing said clinical element model for said dietary item to said dietary plan.

3. The method of claim 1, further comprising outputting said clinical element model for said dietary item to at least one of a clinical application and an electronic medical record.

4. The method of claim 1, further comprising constructing a library of clinical element models for a plurality of dietary items for use in mapping said dietary item to a clinical element model based on said input.

5. The method of claim 1, wherein said receiving input further comprises receiving input via at least one of a barcode, magnetic strip, and radio frequency identifier scan of said dietary item.

6. The method of claim 1, wherein said mapping further comprises mapping said dietary item to a clinical element model based on said input, a clinical element model dictionary, and behavioral rules.

7. The method of claim 1, wherein said library includes standardized food descriptions and relationships and wherein said mapping standardizes a representation of said dietary item using a clinical element model.

8. The method of claim 1, further comprising analyzing an affect of said dietary item on a patient's vital signs using said clinical element model.

9. A system enabling dietary planning and monitoring, said system comprising:
a library of clinical element models representing dietary items;
a clinical subsystem including a dietary plan; and
an input receiving information regarding a dietary item, said information regarding said dietary item translated into a clinical element model for said dietary item using said library, said clinical element model for said dietary item compared to said dietary plan to determine acceptability of said dietary item under said dietary plan.

10. The system of claim 9, wherein said clinical subsystem further comprises at least one of a clinical application and an electronic medical record and wherein said clinical element model for said dietary item is output to at least one of said clinical application and said electronic medical record.

11. The system of claim 9, wherein said input is part of a computer workstation and wherein said input receives said information regarding said dietary item via at least one of a barcode, magnetic strip, and radio frequency identifier scan of said dietary item.

12. The system of claim 9, wherein at least one of said library and said clinical subsystem further comprise a clinical element model dictionary and behavioral rules, wherein said dietary item information is translated into a clinical element model based on said information and said clinical element model dictionary and behavioral rules.

13. The system of claim 9, wherein said library includes standardized food descriptions and relationships and wherein said translating standardizes a representation of said dietary item using a clinical element model.

14. The system of claim 9, wherein said clinical subsystem is configured for use by a clinician to analyze an affect of said dietary item on a patient's vital signs using said clinical element model.

15. A machine-readable medium including a set of instructions for execution by a computing device, said set of instructions comprising:
an input routine receiving input regarding a dietary item, said input including an identifier for said dietary item and contents of said dietary item;
a mapping routine mapping said dietary item to a clinical element model based on said input; and
an output routine providing said clinical element model for said dietary item in conjunction with a dietary plan, the dietary plan including dietary items and relationships between dietary items implemented according to a clinical element model.

16. The machine-readable medium of claim 15, wherein said clinical element model for said dietary item is output to at least one of a clinical application and an electronic medical record.

17. The machine-readable medium of claim 15, further comprising an analysis routine to analyze an affect of said dietary item on a patient's vital signs using said clinical element model.

18. The machine-readable medium of claim 15, further comprising an analysis routine to determine whether said dietary item complies with said dietary plan using said clinical element model.

19. The machine-readable medium of claim 15, wherein said mapping routine utilizes at least one of a clinical element model dictionary and behavioral rules to map said dietary item to a clinical element model.

20. The machine-readable medium of claim 15, wherein said mapping routine standardizes a representation of said dietary item using a clinical element model based on a library of clinical element models for dietary items.
